(19) United States
(12) Patent Application Publication
(10) Pub. No.: US 2026/0338317 A1
(43) Pub. Date: Oct. 29, 2026

(54) A-FRAME ASSEMBLY AND METHOD OF ASSEMBLING THEREOF

(71) Applicant: APA SOLAR, LLC, Ridgeville Corners, OH (US)

(72) Inventors: Shawn Jeremy Ramey, Ney, OH (US); Joseph Von Deylen, Whitehouse, OH (US); Josh Von Deylen, Bryan, OH (US)

(21) Appl. No.: 19/657,924

(22) Filed: Apr. 24, 2026

Related U.S. Application Data
(60) Provisional application No. 63/794,444, filed on Apr. 25, 2025.

(51) Int. Cl. F16M 11/22; F16M 11/10; H02S 20/32

(52) U.S. Cl. CPC F16M 11/22; F16M 11/10; H02S 20/32

(57) ABSTRACT

An A-frame assembly can include an elongated member having a first leg, a second leg, and an intermediate portion disposed between the first leg and the second leg. A first notch can be formed in the elongated member between the first leg and the intermediate portion to define a first hinge point, and a second notch can be formed between the intermediate portion and the second leg to define a second hinge point. The first leg and the second leg can each be selectively positioned between an undeployed configuration where the legs are substantially axially aligned with the intermediate portion, and a deployed configuration where the legs are each positioned at a predetermined angle relative to a longitudinal axis of the intermediate portion. A bracket can couple one of the legs to the intermediate portion to define the predetermined angle and maintain the A-frame assembly in the deployed configuration.

### CROSS-REFERENCE TO RELATED APPLICATIONS

This application claims the benefit of U.S. Provisional Application No. 63/794,444, filed on Apr. 25, 2025. The entire disclosure of the above application is incorporated herein by reference.

### FIELD

The present technology relates to a support structure for a solar tracking system, and, more particularly, to an A-frame assembly selectively positionable between an undeployed configuration and a deployed configuration.

### INTRODUCTION

This section provides background information related to the present disclosure which is not necessarily prior art.

A solar tracking system can rely on mounting structures to support and orient solar panels toward the sun throughout the day. An A-frame can provide the structural foundation needed to maintain proper solar panel alignment. A-frames can be subject to substantial mechanical loads, including wind, snow, and the dynamic forces associated with continuous solar panel movement. The structural demands of solar tracking systems can require mounting structures that can maintain rigidity and stability under a variety of environmental and operational conditions.

Certain A-frame structures can feature rigid triangular configurations that, while providing necessary stability for solar tracking equipment, can create substantial inefficiencies in transportation and storage. The non-collapsible nature of these A-frames can militate against compact stacking and packaging, resulting in shipping containers and trucks reaching their volume capacity before achieving their weight limits. This volume-based limitation can reduce the overall transport efficiency, making large-scale deployment less economical. The inherent bulk of these A-frame structures can result in a significant portion of available shipping space being underutilized.

Logistical challenges associated with rigid A-frame structures can have broad supply chain implications that extend beyond simple shipping costs. Storage facilities can be required to accommodate the inefficient shape of these structures, leading to increased warehouse costs and reduced storage capacity. The irregular dimensions of A-frame components can complicate automated warehouse handling systems, requiring manual intervention and slowing down fulfillment operations. These inefficiencies can compound over the course of large-scale solar installations, contributing to significant increases in overall project costs.

An installation site can face similar space constraints when receiving and storing components prior to assembly. The bulky nature of rigid A-frame structures can necessitate additional staging areas at installation sites, potentially causing project complications and delays. The requirement for expanded staging areas can increase site preparation costs and extend project timelines. These space inefficiencies can reduce overall operational efficiency and contribute to higher per-unit installation costs.

Certain designs attempt to modify the basic A-frame structure to address some of these logistical challenges, but these modifications can often compromise the stability required for supporting solar tracking systems. Some modular support structures can introduce multiple connection points to allow for partial disassembly, but this approach can reduce overall rigidity and introduce potential failure points during operation. The increased number of components associated with these modular approaches can also complicate the assembly process and increase labor costs. The tradeoff between logistical efficiency and structural integrity presents a persistent challenge in the design of A-frame support structures for solar tracking applications.

The carbon footprint associated with transporting rigid A-frame structures can be disproportionately large relative to the actual weight of the components being shipped. Increased transportation requirements resulting from poor shipping density can contribute to higher carbon emissions per unit deployed. The environmental impact of these inefficiencies can be significant when considered across the scale of large solar installations requiring hundreds or thousands of support structures. The inability to optimize shipping density can therefore have both economic and environmental consequences for large-scale solar energy projects.

Manufacturing and quality control processes for rigid A-frame structures can also be affected by the fixed triangular geometry of these components. The non-flat profile of assembled A-frame structures can complicate automated manufacturing processes, requiring specialized handling equipment and fixturing. Quality control inspections can be more difficult to perform consistently when components cannot be presented in a uniform, flat orientation. These manufacturing challenges can increase production costs and reduce throughput, further contributing to the overall cost inefficiency associated with rigid A-frame support structures.

Accordingly, there is a continuing need for an A-frame support structure that can maintain structural integrity while significantly improving shipping density and logistics efficiency. Desirably, such a support structure can allow for a compact transportation configuration without compromising the stability required for solar tracking applications, while also simplifying storage, reducing warehouse and staging space requirements, streamlining manufacturing and quality control processes, and reducing overall project costs through improved shipping efficiency.

### SUMMARY

In concordance with the instant disclosure, an A-frame assembly that can maintain structural integrity while significantly improving shipping density and logistics efficiency, has surprisingly been discovered. The present technology includes articles of manufacture, systems, and processes that relate to an A-frame assembly that can maintain structural integrity while significantly improving shipping density and logistics efficiency.

In certain embodiments, an A-frame assembly is provided that includes an elongated member having a first leg, a second leg, and an intermediate portion disposed between the first leg and the second leg. A first notch can be formed in the elongated member between the first leg and the intermediate portion, the first notch defining a first hinge point, and a second notch can be formed in the elongated member between the intermediate portion and the second leg, the second notch defining a second hinge point. The first leg and the second leg can each be selectively positioned between an undeployed configuration where the first leg and the second leg are substantially axially aligned with the intermediate portion, and a deployed configuration where the first leg and the second leg are each positioned at a predetermined angle relative to a longitudinal axis of the intermediate portion. A plurality of brackets can each couple one of the first leg and the second leg to the intermediate portion to define the predetermined angle therebetween and to maintain the A-frame assembly in the deployed configuration.

In certain embodiments, a kit for an A-frame assembly is provided that includes a plurality of elongated members, each elongated member having a first leg, a second leg, and an intermediate portion disposed between the first leg and the second leg. A first notch can be formed between the first leg and the intermediate portion to define a first hinge point, and a second notch can be formed between the intermediate portion and the second leg to define a second hinge point. The first leg and the second leg of each elongated member can each be selectively positioned between an undeployed configuration where the first leg and the second leg are substantially axially aligned with the intermediate portion, and a deployed configuration where the first leg and the second leg are each positioned at a predetermined angle relative to a longitudinal axis of the intermediate portion. The kit can further include a plurality of brackets, each bracket capable of coupling one of the first leg and the second leg to the intermediate portion to define the predetermined angle therebetween and to maintain the A-frame assembly in the deployed configuration, and a plurality of bearing housing assemblies capable of being coupled to each intermediate portion of the plurality of elongated members.

In certain embodiments, a method for assembling an A-frame assembly is provided. The method can include providing an A-frame assembly having an elongated member with a first leg, a second leg, and an intermediate portion, wherein a first notch can define a first hinge point and a second notch can define a second hinge point. The method can include receiving the elongated member in an undeployed configuration where the first leg and the second leg are substantially axially aligned with the intermediate portion. The method can further include positioning each of the first leg and the second leg at a predetermined angle relative to a longitudinal axis of the intermediate portion to transition the elongated member to a deployed configuration, and coupling a bracket to one of the first leg and the second leg to the intermediate portion to define the predetermined angle therebetween and to maintain the A-frame assembly in the deployed configuration.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a bottom perspective view of an elongated member of an A-frame assembly, according to an embodiment of the present disclosure;

FIG. 2 is a top perspective view of the elongated member of the A-frame assembly, according to the embodiment shown in FIG. 1;

FIG. 3 is a bottom perspective view of a bracket of an A-frame assembly, according to an embodiment of the present disclosure;

FIG. 4 is a bottom perspective view of the bracket coupled to the elongated member of the A-frame assembly, according to the embodiments shown in FIGS. 1 and 3;

FIG. 5 is a bottom perspective view of the elongated member in a deployed configuration, according to an embodiment of the present disclosure;

FIG. 6 is a bottom perspective view of the A-frame assembly in the deployed configuration with a plurality of brackets coupled to the elongated member, according to an embodiment of the present disclosure;

FIG. 7 is a top perspective view of the A-frame assembly in the deployed configuration with a plurality of brackets coupled to the elongated member, according to an embodiment of the present disclosure;

FIG. 8 is a top perspective view of a kit for A-frame assembly in the deployed configuration with a plurality of brackets coupled to the elongated member for coupling to a bearing housing assembly shown in an exploded view, according to an embodiment of the present disclosure;

FIG. 9 is a top perspective view of a kit for A-frame assembly in the deployed configuration with a plurality of brackets coupled to the elongated member and where the bearing housing assembly is coupled to the elongated member, according to an embodiment of the present disclosure;

FIG. 10 is a perspective view of a stack of a plurality of elongated members used in A-frame assemblies, each of the elongated members in an undeployed configuration, according to an embodiment of the present disclosure; and

FIGS. 11 and 12 provide a flowchart illustrating a method of assembly for an A-frame assembly, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

An A-frame assembly can include an elongated member that can serve as a foundation of the A-frame assembly in providing a solar installation support structure. The elongated member can have two outer legs and an intermediate section, with a notch cut into the member at each junction between a leg and the intermediate section. These notches can act as hinge points, allowing the legs to be flat and in line with the intermediate section for shipping and storage, or bent toward the intermediate section to form the familiar A-frame shape for use in the field. Once the legs can be positioned at a predetermined angle, where the predetermined angle can be defined by the notches, a bracket can be fastened across the junction of each leg and the intermediate section to lock the assembly in its deployed shape. A bearing housing assembly can also be attached to the intermediate section to support a rotating shaft or axle, such as those found in solar tracking systems. Because the elongated member can be shipped and stored in a completely flat configuration, an increased number of units can be packed into a single shipping container or truck before reaching volume limitations, reducing transportation costs per unit. Storage at warehouses and installation sites can also be more efficient, as flat units can be stacked and nested together in a compact arrangement. Once delivered, the assembly can be quickly deployed on-site by bending the legs at the notches and securing the brackets, reducing assembly time and labor costs.

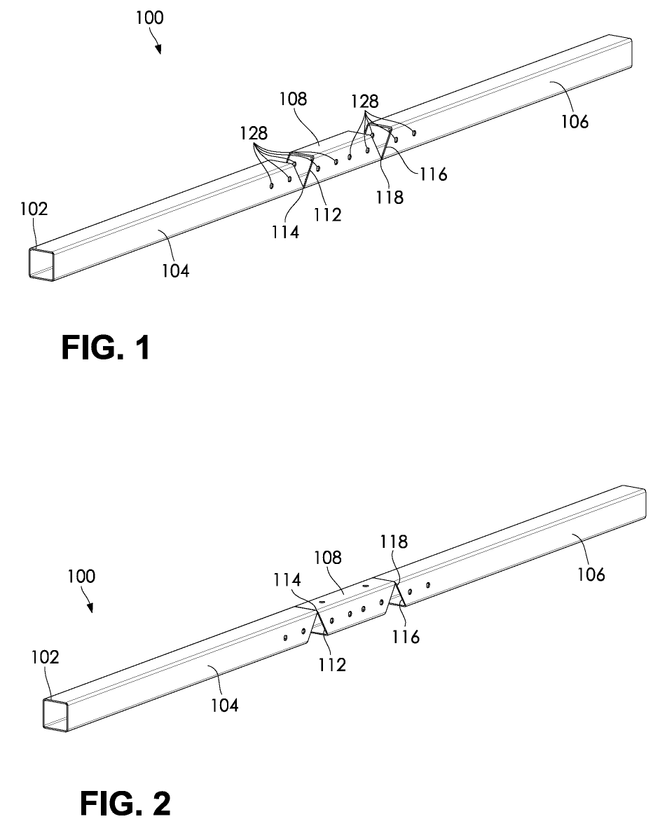

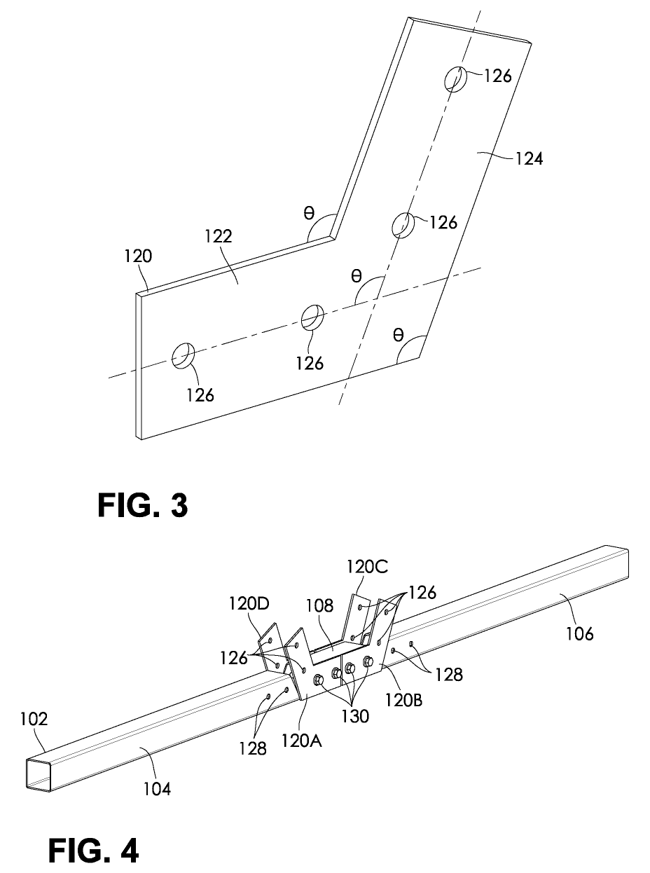

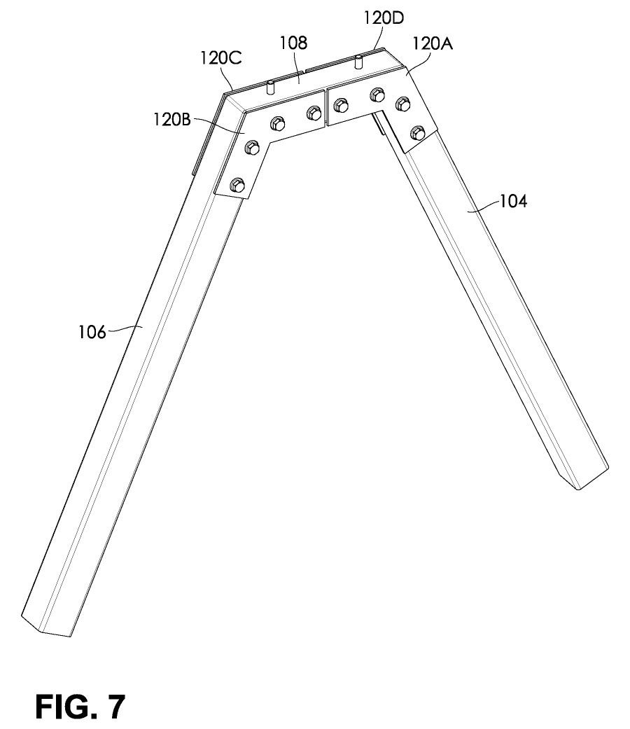

Referring now to FIGS. 1-7, in certain embodiments, an A-frame assembly is provided. The A-frame assembly 100 can be suitable for use in solar tracking systems, providing structural support for solar tracking equipment. The A-frame assembly 100 can be selectively positioned between an undeployed configuration and a deployed configuration, allowing for compact transportation and storage while maintaining structural integrity in the field. The A-frame assembly 100 can be manufactured from various structural materials, including steel, aluminum, and other suitable metals, selected based on the desired strength, weight, and durability characteristics of the application.

The A-frame assembly 100 can include an elongated member 102. The elongated member 102 can have a first leg 104, a second leg 106, and an intermediate portion 108 disposed between the first leg 104 and the second leg 106. The elongated member 102 can be formed as a single, continuous member, with the first leg 104, the second leg 106, and the intermediate portion 108 forming integral regions of the elongated member 102. The elongated member 102 can be manufactured from a material suitable for supporting solar tracking equipment, including steel, aluminum, and other suitable materials.

The elongated member 102 can include a square cross-sectional profile. A square cross-sectional profile can provide increased rigidity and resistance to twisting, making it suitable for applications requiring enhanced structural stability. Alternatively, the elongated member 102 can include a tube having a rectangular cross-sectional profile, which can offer similar rigidity characteristics while accommodating different dimensional requirements. The elongated member 102 can also include a tube having a circular cross-sectional profile, which can offer improved resistance to bending in multiple directions, making it suitable for applications involving dynamic loads or rotational forces.

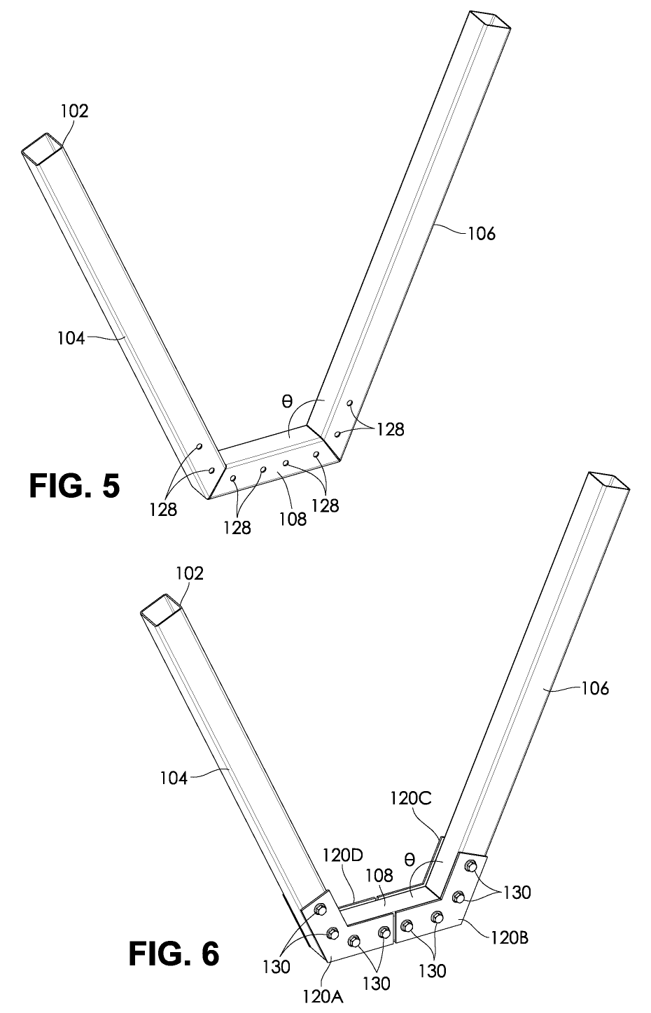

The first leg 104 and the second leg 106 of the elongated member 102 can each be selectively positioned between an undeployed configuration and a deployed configuration. In the undeployed configuration, the first leg 104 and the second leg 106 can be substantially axially aligned with the intermediate portion 108, providing a flat, compact profile suitable for shipping and storage where the first leg 104, the second leg 106, and the intermediate portion 108 are in line with each other. Examples of the undeployed configuration are shown in FIGS. 1, 2, 4 and 10 . In the deployed configuration, the first leg 104 and the second leg 106 can each be positioned at a predetermined angle ϴ relative to a longitudinal axis of the intermediate portion 108, forming the A-frame shape required for operational use. Examples of the deployed configuration are shown in FIGS. 5-9. The ability to selectively position the first leg 104 and the second leg 106 between the undeployed configuration and the deployed configuration can allow for significant improvements in shipping density and storage efficiency.

The first leg 104 and the second leg 106 of the elongated member 102 can be of substantially equal length. Equal lengths can provide a symmetrical A-frame configuration in the deployed configuration, distributing structural loads evenly between the first leg 104 and the second leg 106. Alternatively, the first leg 104 and the second leg 106 can be of different lengths, providing an asymmetrical configuration suited to applications requiring unequal leg heights or offsets. The predetermined angle ϴ of the first leg 104 relative to the longitudinal axis of the intermediate portion 108 can differ from the predetermined angle ϴ of the second leg 106 relative to the longitudinal axis of the intermediate portion 108, providing a non-symmetrical A-frame assembly 100 suited to applications requiring different angular relationships between the respective legs and the intermediate portion 108.

The intermediate portion 108 can be disposed between the first leg 104 and the second leg 106 of the elongated member 102. The intermediate portion 108 can serve as the central structural region of the elongated member 102, providing a mounting location for additional components such as a bearing housing assembly 110. The intermediate portion 108 can be substantially parallel to a ground surface when the A-frame assembly 100 is in the deployed configuration, providing a stable and level mounting surface. The length and cross-sectional profile of the intermediate portion 108 can be selected based on the structural requirements of the intended application.

A first notch 112 can be formed in the elongated member 102 between the first leg 104 and the intermediate portion 108. The first notch 112 can be formed by removing material from the elongated member 102 at a junction between the first leg 104 and the intermediate portion 108. The first notch 112 can define a first hinge point 114, creating a region of reduced cross-sectional area that can facilitate controlled bending or pivoting of the first leg 104 relative to the intermediate portion 108. The geometry of the first notch 112, including its depth, width, and shape, can be selected to control the range of motion, the bending force required to transition between the undeployed configuration and the deployed configuration, and the stability of the deployed configuration. In certain embodiments, the first notch 112 can be configured at a supplementary angle to the predetermined angle ϴ of the first leg 104 relative to the longitudinal axis of the intermediate portion 108.

A second notch 116 can be formed in the elongated member 102 between the intermediate portion 108 and the second leg 106. The second notch 116 can be formed by removing material from the elongated member 102 at the junction between the intermediate portion 108 and the second leg 106. The second notch 116 can define a second hinge point 118, creating a region of reduced cross-sectional area that can facilitate controlled bending or pivoting of the second leg 106 relative to the intermediate portion 108. The geometry of the second notch 116 can be selected independently of the first notch 112, allowing for symmetrical or non-symmetrical A-frame configurations depending on the requirements of the intended application. In certain embodiments, the second notch 116 can be configured at a supplementary angle to the predetermined angle ϴ of the second leg 106 relative to the longitudinal axis of the intermediate portion 108.

In certain embodiments, the first notch 112 and the second notch 116 can each be V-shaped. A V-shaped notch can provide a well-defined bending point that can facilitate controlled and repeatable positioning of the first leg 104 and the second leg 106 relative to the intermediate portion 108. The V-shape can allow the legs 104, 106 to close fully against the intermediate portion 108 while providing a defined stop angle in the deployed configuration. The included angle of the V-shaped notch can supplement the predetermined angle ϴ of the deployed configuration, ensuring that the first leg 104 and the second leg 106 can be positioned at the correct angle when fully deployed.

It should be understood that the geometry of each of the first notch 112 and the second notch 116 can control one of a range of motion of the first leg 104 and the second leg 106, a bending force required to transition between the undeployed configuration and the deployed configuration, and a stability of the deployed configuration. A notch with a wider included angle can allow for a greater range of motion, while a notch with a narrower included angle can provide increased stability in the deployed configuration. The depth of each notch can affect the bending force required to transition between configurations, with deeper notches generally requiring less force to bend. The dimensions and geometry of the first notch 112 and the second notch 116 can be selected by one having ordinary skill in the art to achieve the desired performance characteristics for a given application.

The A-frame assembly 100 can include a plurality of brackets 120. Each bracket 120 of the plurality of brackets 120 can be configured to couple one of the first leg 104 and the second leg 106 to the intermediate portion 108. The plurality of brackets 120 can define the predetermined angle ϴ between the coupled leg and the intermediate portion 108 and can maintain the A-frame assembly 100 in the deployed configuration. The plurality of brackets 120 can be formed from a structural material compatible with the elongated member 102, such as steel or aluminum, to provide a secure and durable connection.

Each bracket 120 of the plurality of brackets 120 can include a first section 122 and a second section 124 formed at an angle relative to each other. The first section 122 can be positioned against one of the first leg 104 and the second leg 106, while the second section 124 can be positioned against the intermediate portion 108. The angle between the first section 122 and the second section 124 can correspond to the predetermined angle ϴ of the deployed configuration, ensuring that the bracket 120 can maintain the correct angular relationship between the coupled leg and the intermediate portion 108. The first section 122 and the second section 124 can each include one or more attachment features 126, such as apertures or slots, to facilitate secure attachment to the elongated member 102.

The plurality of brackets 120 can include a first bracket 120A and a second bracket 120B each configured to couple to a first side of the elongated member 102, and a third bracket 120C and a fourth bracket 120D each configured to couple to a second side of the elongated member 102 opposite the first side. The first bracket 120A and the third bracket 120C can each couple the first leg 104 to the intermediate portion 108 on opposite sides of the elongated member 102. The second bracket 120B and the fourth bracket 120D can each couple the second leg 106 to the intermediate portion 108 on opposite sides of the elongated member 102. This four-bracket arrangement can provide a secure and balanced connection between the legs and the intermediate portion 108, distributing structural loads across both sides of the elongated member 102.

In certain embodiments, the plurality of brackets 120 can be integrally formed into a unitary bracket where brackets 120A, 120B, 120C, 120D can be combined into a single bracket. The unitary bracket can couple the first leg 104 and the second leg 106 to the intermediate portion 108 on both the first side and the second side of the elongated member 102. The unitary bracket can provide equivalent structural support to the plurality of brackets 120 while reducing the number of components required for assembly of the A-frame assembly 100. The unitary bracket can simplify field assembly by reducing the number of fastening operations required to secure the legs 104, 106 in the deployed configuration.

In certain embodiments, the plurality of brackets 120 can be combined into two brackets. A first combined bracket can include brackets 120A, 120B, coupling both the first leg 104 and the second leg 106 to the intermediate portion 108 on the first side of the elongated member 102. A second combined bracket can integrate brackets 120C, 120D, coupling both the first leg 104 and the second leg 106 to the intermediate portion 108 on the second side of the elongated member 102 opposite the first side. Alternatively, the first combined bracket can include brackets 120A, 120C, coupling the first leg 104 to the intermediate portion 108 on both the first side and the second side of the elongated member 102, and a second combined bracket can include brackets 120B, 120D, coupling the second leg 106 to the intermediate portion 108 on both the first side and the second side of the elongated member 102. The two-bracket configuration can reduce the number of components required for assembly while maintaining the structural support provided by brackets 120A, 120B, 120C, 120D.

The A-frame assembly 100 can include a plurality of apertures 128 formed along a length of the elongated member 102. The plurality of apertures 128 can be disposed adjacent to at least one of the first notch 112 and the second notch 116, positioning them to facilitate attachment of the plurality of brackets 120 at the hinge points of the elongated member 102. The plurality of apertures 128 can be centered along a longitudinal axis of the elongated member 102, providing a consistent and symmetrical attachment pattern for the plurality of brackets 120.

The A-frame assembly 100 can include a plurality of fasteners 130 configured to be selectively received in the plurality of apertures 128 to secure each bracket 120 of the plurality of brackets 120 to the elongated member 102. The plurality of fasteners 130 can provide a secure connection between each bracket 120 and the elongated member 102 while allowing for selective attachment and removal of the brackets 120 as needed. The plurality of fasteners 130 can include a bolt, a nut, a washer, a screw, a pin, a rivet, a clip, a quick-release pin, and combinations thereof. Quick-release pins or locking mechanisms can be included in the plurality of fasteners 130 to facilitate easy assembly and disassembly of the A-frame assembly 100 in the field.

The plurality of fasteners 130 can include a bolt, a nut, a washer, a screw, a pin, a rivet, a clip, a quick-release pin, and combinations thereof. A bolt and nut combination can provide a secure and adjustable connection between each bracket 120 and the elongated member 102, allowing for controlled tightening and loosening of the connection as needed. A quick-release pin can facilitate rapid assembly and disassembly of the A-frame assembly 100 in the field, reducing the time and tools required for deployment. The selection of fastener type from the group can be based on the structural requirements of the application, the tools available in the field, and the frequency with which the A-frame assembly 100 can be expected to be assembled and disassembled.

The A-frame assembly 100 can further include a bearing housing assembly 110 configured to be secured to the intermediate portion 108 of the elongated member 102. The bearing housing assembly 110 can provide rotational support for a shaft, axle, or other rotating component of a solar tracking system, facilitating smooth and controlled rotational movement of the solar tracking equipment. The bearing housing assembly 110 can be selectively attached to and removed from the intermediate portion 108 of the elongated member 102, allowing for easy replacement or maintenance of the bearing housing assembly 110 without disturbing the remainder of the A-frame assembly 100. The positioning of the bearing housing assembly 110 on the intermediate portion 108 can place the rotational support at a central and structurally stable location within the A-frame assembly 100.

The bearing housing assembly 110 can include a housing bracket 132, a housing 134 configured to enclose and support a bearing, and a plurality of fasteners 130 configured to selectively secure the housing bracket 132 to the intermediate portion 108 of the elongated member 102. The housing bracket 132 can be a structural component that can support and align the housing 134 relative to the intermediate portion 108, and can include a plurality of mounting features 136 such as apertures, slots, or tabs to enable attachment to the elongated member 102. The housing 134 can enclose and support a bearing, protecting it from contaminants such as dirt, dust, and moisture, while also retaining lubrication to minimize friction and extend the bearing's lifespan. The plurality of fasteners 130 of the bearing housing assembly 110 can be received in the plurality of apertures 128 of the elongated member 102 and the plurality of mounting features 136 of the housing bracket 132 to provide a secure and selectively removable connection between the bearing housing assembly 110 and the intermediate portion 108.

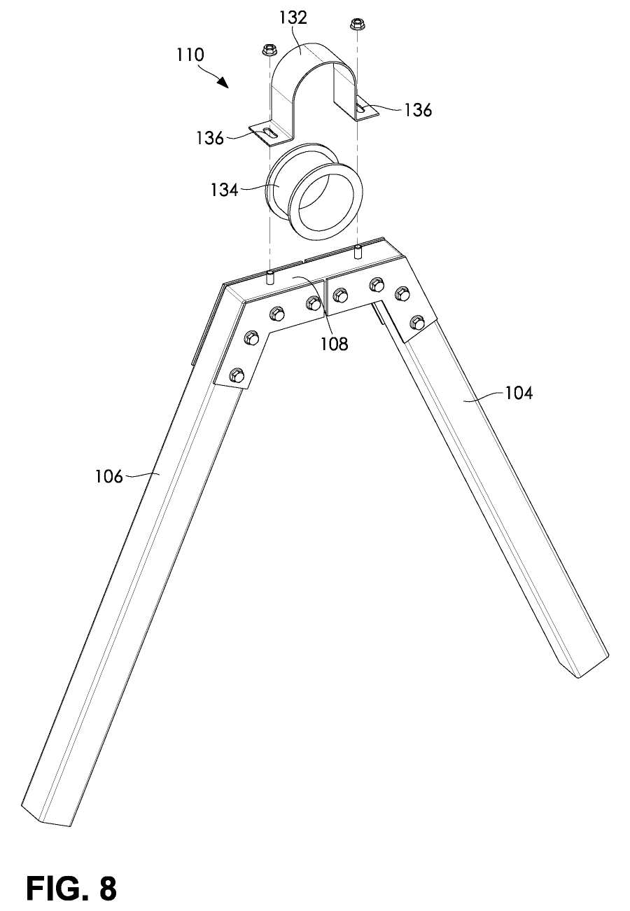

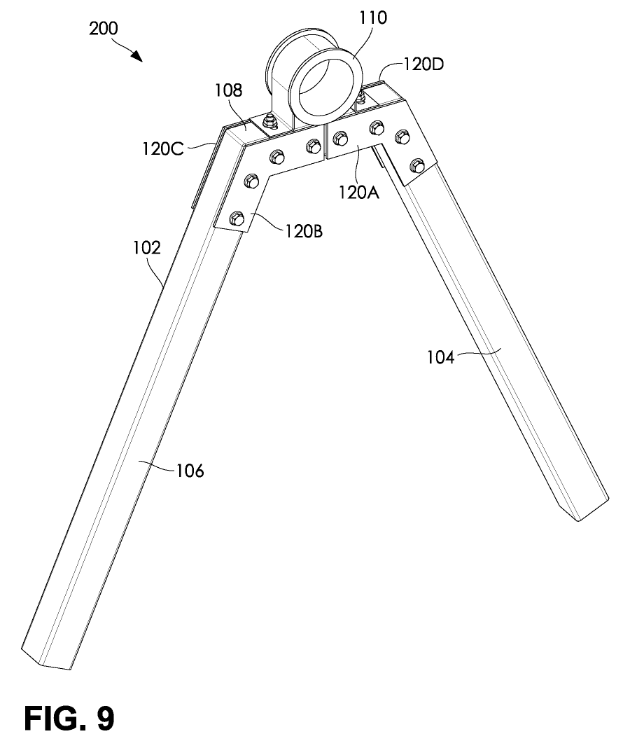

Referring now to FIGS. 8-9, in certain embodiments, a kit 200 for an A-frame assembly 100 is provided. The kit 200 can include the A-frame assembly 100 as described herein, including the elongated member 102, the plurality of brackets 120, and the plurality of fasteners 130. The kit 200 can be suitable for use in solar tracking systems, providing all of the components needed to assemble and deploy a fully functional A-frame support structure in the field. The components of the kit 200 can be packaged together in a compact arrangement, taking advantage of the flat undeployed configuration of the elongated member 102 to minimize packaging volume during shipping and storage.

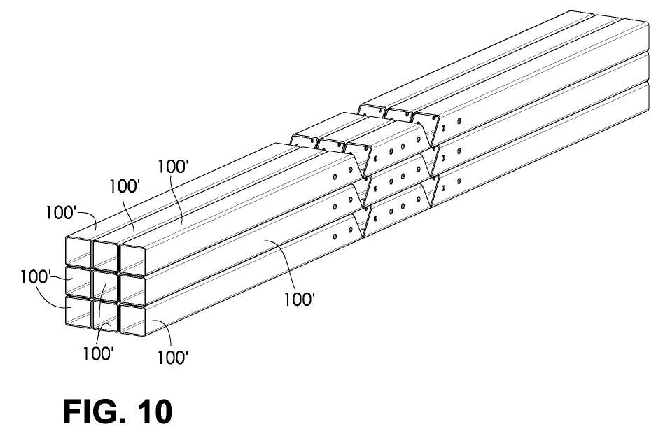

The kit 200 can include a plurality of elongated members 102', each elongated member 102' being the elongated member 102 as described herein. The plurality of elongated members 102' can be shipped and stored in the undeployed configuration, allowing them to be stacked and nested together in a compact arrangement, as shown in the example depicted in FIG. 10. The number of elongated members 102' included in the kit 200 can be selected based on the requirements of the intended installation, allowing the kit 200 to be scaled to accommodate installations of varying sizes. Each elongated member 102' of the plurality of elongated members 102' can include a first notch 112 defining a first hinge point 114 and a second notch 116 defining a second hinge point 118, as described herein.

The kit 200 can include a plurality of brackets 120 as described herein. The plurality of brackets 120 can be provided in a quantity sufficient to secure each of the first leg 104 and the second leg 106 of each elongated member 102 of the plurality of elongated members 102' to the respective intermediate portion 108 in the deployed configuration. Each bracket 120 of the plurality of brackets 120 can include a first section 122 and a second section 124 formed at an angle relative to each other corresponding to the predetermined angle ϴ of the deployed configuration. The plurality of brackets 120 can be packaged compactly within the kit 200, as their flat or angled profile can allow for efficient stacking and storage alongside the elongated members 102'.

The kit 200 can include the bearing housing assembly 110. The bearing housing assembly 110 can be configured to be coupled to the intermediate portion 108 of the elongated member 102 to provide rotational support for a shaft, axle, or other rotating component of a solar tracking system. The bearing housing assembly 110 can be provided as a pre-assembled unit within the kit 200, reducing the number of assembly steps required in the field. The bearing housing assembly 110 can be selectively attached to and removed from the intermediate portion 108 of the elongated member 102, allowing for easy replacement or maintenance of the bearing housing assembly 110 as needed.

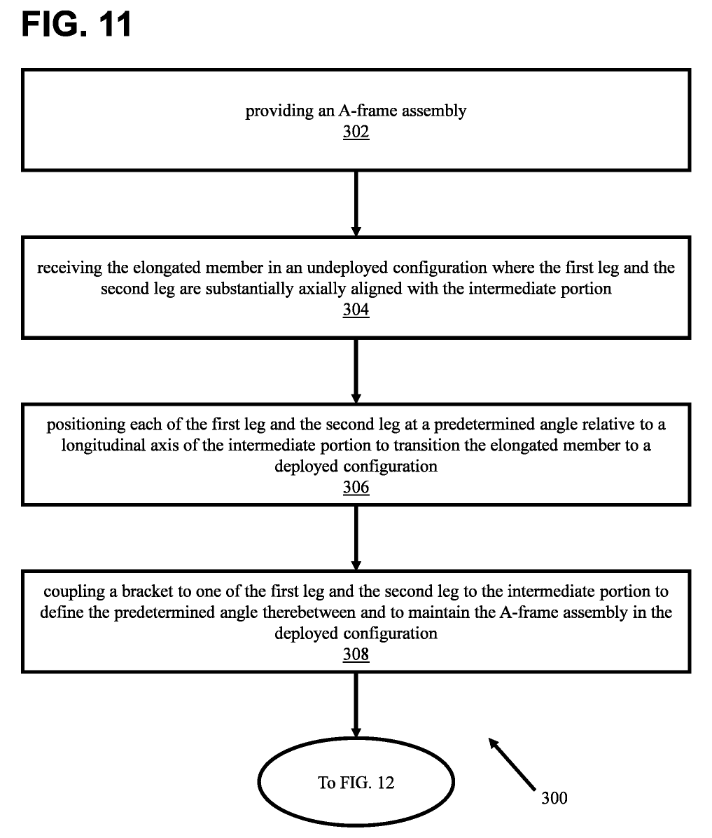

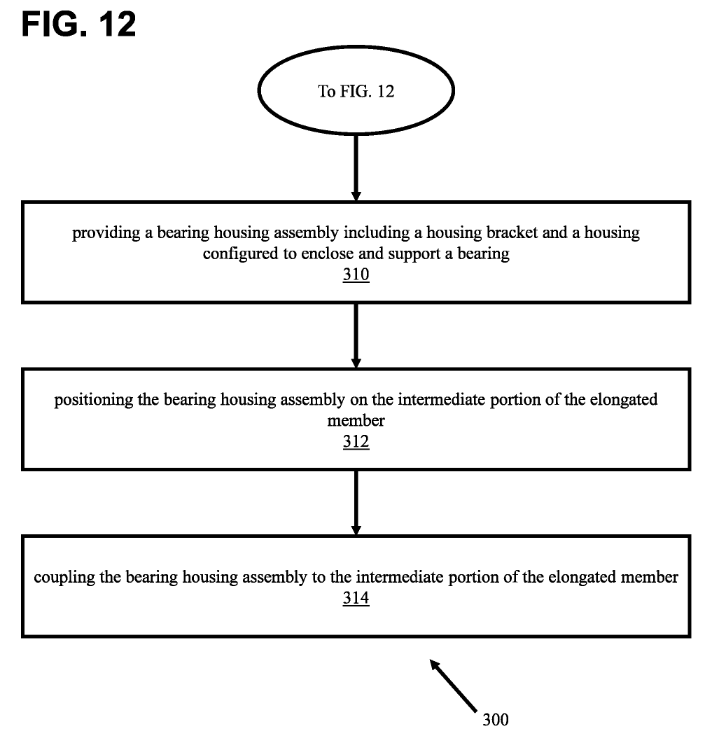

Referring now to FIGS. 11-12, in certain embodiments, a method 300 for assembling an A-frame assembly 100 is provided. The method 300 can be performed using the A-frame assembly 100 as described herein, including the elongated member 102, the plurality of brackets 120, and the plurality of fasteners 130. The method 300 can allow for efficient assembly of the A-frame assembly 100 in the field, taking advantage of the compact undeployed configuration of the elongated member 102 to minimize shipping and storage requirements prior to assembly. The method 300 can be performed by a single operator with minimal tools, reducing labor costs and assembly time at the installation site.

The method 300 can include a step 302 of providing the A-frame assembly 100 as described herein. The A-frame assembly 100 provided in step 302 can include the elongated member 102 having the first leg 104, the second leg 106, and the intermediate portion 108, as well as the first notch 112 defining the first hinge point 114 and the second notch 116 defining the second hinge point 118, as described herein. The A-frame assembly 100 can further include the plurality of brackets 120 and the plurality of fasteners 130 as described herein. The A-frame assembly 100 can be provided in the undeployed configuration, allowing for compact shipping and storage prior to assembly.

The method 300 can include a step 304 of receiving the elongated member 102 in an undeployed configuration where the first leg 104 and the second leg 106 are substantially axially aligned with the intermediate portion 108. In the undeployed configuration, the elongated member 102 can present a flat, compact profile that can minimize packaging volume during shipping and storage. The undeployed configuration can allow a greater number of elongated members 102 to be transported in a single shipment before reaching trailer volume limitations. The elongated member 102 can be received in the undeployed configuration at a warehouse, distribution center, or installation site, and can be stored in the undeployed configuration until assembly can be performed.

The method 300 can include a step 306 of positioning each of the first leg 104 and the second leg 106 at a predetermined angle ϴ relative to a longitudinal axis of the intermediate portion 108 to transition the elongated member 102 to a deployed configuration. Positioning each of the first leg 104 and the second leg 106 can include bending the elongated member 102 at each of the first notch 112 and the second notch 116, with the first notch 112 and the second notch 116 each defining a hinge point that can facilitate controlled and repeatable bending of the elongated member 102. The geometry of the first notch 112 and the second notch 116 can control the range of motion available during step 306, ensuring that the first leg 104 and the second leg 106 can be positioned at the correct predetermined angle Ø for the deployed configuration. The predetermined angle ϴ can be achieved by bending the elongated member 102 at each of the first notch 112 and the second notch 116 until the legs contact or approach a stop defined by the notch geometry.

The method 300 can include a step 308 of coupling a bracket 120 to one of the first leg 104 and the second leg 106 to the intermediate portion 108 to define the predetermined angle Ø therebetween and to maintain the A-frame assembly 100 in the deployed configuration. Coupling the bracket 120 in step 308 can include inserting a plurality of fasteners 130 through a plurality of apertures 128 formed in the elongated member 102 and a plurality of attachment features 126 of the bracket 120 to secure the bracket 120 to one of the first leg 104 and the second leg 106 and the intermediate portion 108. The plurality of fasteners 130 can be selected from a bolt, a nut, a washer, a screw, a pin, a rivet, a clip, a quick-release pin, and combinations thereof, as described herein. The coupling of the bracket 120 in step 308 can lock the first leg 104 and the second leg 106 at the predetermined angle Ø relative to the intermediate portion 108, maintaining the A-frame assembly 100 in the deployed configuration for operational use.

The method 300 can include a step 310 of providing a bearing housing assembly 110 including a housing bracket 132 and a housing 134 configured to enclose and support a bearing. The bearing housing assembly 110 provided in step 310 can be the bearing housing assembly 110 as described herein, including the housing bracket 132, the housing 134, and a plurality of fasteners 130. The housing 134 can enclose and support a bearing to provide rotational support for a shaft, axle, or other rotating component of a solar tracking system. The bearing housing assembly 110 can be provided as a pre-assembled unit, reducing the number of assembly steps required in the field.

The method 300 can include a step 312 of positioning the bearing housing assembly 110 on the intermediate portion 108 of the elongated member 102. The bearing housing assembly 110 can be positioned such that the plurality of mounting features 136 of the housing bracket 132 can be in substantial alignment with the plurality of apertures 128 of the intermediate portion 108. The positioning of the bearing housing assembly 110 on the intermediate portion 108 can place the rotational support at a central and structurally stable location within the A-frame assembly 100. The bearing housing assembly 110 can be held in position on the intermediate portion 108 during step 312 until the plurality of fasteners 130 can be inserted in step 314 to secure the bearing housing assembly 110 in place.

The method 300 can include a step 314 of coupling the bearing housing assembly 110 to the intermediate portion 108 of the elongated member 102. Coupling the bearing housing assembly 110 in step 314 can include inserting a plurality of fasteners 130 through the plurality of mounting features 136 of the housing bracket 132 and the plurality of apertures 128 of the intermediate portion 108 to secure the bearing housing assembly 110 to the elongated member 102. The plurality of fasteners 130 can be tightened to provide a secure and stable connection between the bearing housing assembly 110 and the intermediate portion 108. The selective nature of the connection provided by the plurality of fasteners 130 can allow the bearing housing assembly 110 to be removed and replaced without disturbing the remainder of the A-frame assembly 100.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An A-frame assembly, comprising:
an elongated member including a first leg, a second leg, and an intermediate portion disposed between the first leg and the second leg, the first leg and the second leg each configured to be selectively positioned between an undeployed configuration where the first leg and the second leg are substantially axially aligned with the intermediate portion, and a deployed configuration where the first leg and the second leg are each positioned at a predetermined angle relative to a longitudinal axis of the intermediate portion;
a first notch formed in the elongated member between the first leg and the intermediate portion, the first notch configured to define a first hinge point;
a second notch formed in the elongated member between the intermediate portion and the second leg, the second notch configured to define a second hinge point; and
a plurality of brackets, each bracket configured to couple one of the first leg and the second leg to the intermediate portion to define the predetermined angle therebetween and to maintain the A-frame assembly in the deployed configuration.

2. The A-frame assembly of claim 1, wherein the elongated member comprises a tube having a square cross-sectional profile.

3. The A-frame assembly of claim 1, wherein the first leg and the second leg are of substantially equal length.

4. The A-frame assembly of claim 1, wherein the first leg and the second leg are of different lengths.

5. The A-frame assembly of claim 1, wherein the predetermined angle of the first leg relative to the longitudinal axis of the intermediate portion differs from the predetermined angle of the second leg relative to the longitudinal axis of the intermediate portion to provide a non-symmetrical A-frame assembly.

6. The A-frame assembly of claim 1, wherein the first notch and the second notch are each V-shaped.

7. The A-frame assembly of claim 1, wherein each bracket of the plurality of brackets includes a first section and a second section formed at an angle relative to each other.

8. The A-frame assembly of claim 7, wherein the angle is the same as the predetermined angle.

9. The A-frame assembly of claim 1, wherein the plurality of brackets includes a first bracket and a second bracket each configured to couple to a first side of the elongated member, and a third bracket and a fourth bracket each configured to couple to a second side of the elongated member opposite the first side.

10. The A-frame assembly of claim 1, further comprising a plurality of apertures formed along a length of the elongated member, and a plurality of fasteners configured to be selectively received in the plurality of apertures to secure each bracket of the plurality of brackets to the elongated member.

11. The A-frame assembly of claim 10, wherein the plurality of apertures is disposed adjacent to at least one of the first notch and the second notch.

12. The A-frame assembly of claim 11, wherein the plurality of fasteners includes a member selected from a group consisting of a bolt, a nut, a washer, a screw, a pin, a rivet, a clip, a quick-release pin, and combinations thereof.

13. The A-frame assembly of claim 1, further comprising a bearing housing assembly configured to be secured to the intermediate portion of the elongated member.

14. The A-frame assembly of claim 13, wherein the bearing housing assembly includes a housing bracket, a housing configured to enclose and support a bearing, and a plurality of fasteners configured to selectively secure the housing bracket to the intermediate portion.

15. An A-frame assembly, comprising:
an elongated member including a first leg, a second leg, and an intermediate portion disposed between the first leg and the second leg, the first leg and the second leg each configured to be selectively positioned between an undeployed configuration where the first leg and the second leg are substantially axially aligned with the intermediate portion, and a deployed configuration where the first leg and the second leg are each positioned at a predetermined angle relative to a longitudinal axis of the intermediate portion;
a first notch formed in the elongated member between the first leg and the intermediate portion, the first notch configured to define a first hinge point;
a second notch formed in the elongated member between the intermediate portion and the second leg, the second notch configured to define a second hinge point;
a plurality of brackets, each bracket configured to couple one of the first leg and the second leg to the intermediate portion to define the predetermined angle therebetween and to maintain the A-frame assembly in the deployed configuration; and
a plurality of apertures formed along a length of the elongated member, and a plurality of fasteners configured to be selectively received in the plurality of apertures to secure each bracket of the plurality of brackets to the elongated member,
wherein:
the elongated member comprises a tube having a square cross-sectional profile,
the first leg and the second leg are of substantially equal length,
the first notch and the second notch are each V-shaped,
each bracket of the plurality of brackets includes a first section and a second section formed at an angle relative to each other, and
the angle is the same as the predetermined angle.

16. A kit for an A-frame assembly, comprising:
a plurality of elongated members, each elongated member including:
a first leg, a second leg, and an intermediate portion disposed between the first leg and the second leg, the first leg and the second leg each configured to be selectively positioned between an undeployed configuration where the first leg and the second leg are substantially axially aligned with the intermediate portion, and a deployed configuration where the first leg and the second leg are each positioned at a predetermined angle relative to a longitudinal axis of the intermediate portion;
a first notch formed between the first leg and the intermediate portion, the first notch configured to define a first hinge point; and
a second notch formed between the intermediate portion and the second leg, the second notch configured to define a second hinge point.

17. The kit of claim 16, further including a plurality of brackets configured to couple one of the first leg and the second leg to the intermediate portion to define the predetermined angle therebetween and to maintain the A-frame assembly in the deployed configuration.

18. The kit of claim 17, further including a plurality of bearing housing assemblies configured to be coupled to each intermediate portion of the plurality of elongated members.

19. A method of assembling an A-frame assembly, comprising:
providing the A-frame assembly of claim 1;
receiving the elongated member in an undeployed configuration where the first leg and the second leg are substantially axially aligned with the intermediate portion;
positioning each of the first leg and the second leg at a predetermined angle relative to a longitudinal axis of the intermediate portion to transition the elongated member to a deployed configuration; and
coupling a bracket to one of the first leg and the second leg to the intermediate portion to define the predetermined angle therebetween and to maintain the A-frame assembly in the deployed configuration.

20. The method of claim 19, further comprising:
providing a bearing housing assembly including a housing bracket and a housing configured to enclose and support a bearing;
positioning the bearing housing assembly on the intermediate portion of the elongated member; and
coupling the bearing housing assembly to the intermediate portion of the elongated member.
